(19) United States
(12) Patent Application Publication
(10) Pub. No.: US 2026/0191631 A1
(43) Pub. Date: Jul. 9, 2026

(54) Expandable bone implant for veterinary orthopaedic surgery, orthopaedic system and method for manufacturing the implant

(71) Applicant: IN LIFE VET SA, Bulle (CH)

(72) Inventor: Guillaume LACAZE, La Rippe (CH)

(73) Assignee: IN LIFE VET SA, Bulle (CH)

(21) Appl. No.: 19/340,554

(22) Filed: Sep. 25, 2025

(30) Foreign Application Priority Data
Sep. 25, 2024 (EP) 24202392.7

(51) Int. Cl. A61D 1/00

(52) U.S. Cl. CPC A61D 1/00

(57) ABSTRACT

An expandable bone implant having folded and deployed configurations, two faces including a flange for contact with bone tissue, each flange supported by two support arms, by a hinge on the central shaft and a hinge under the respective flange of each support arm; wherein an expansion ring is arranged on the same axis as the central shaft; two expansion arms are articulated to a flange and to the expansion ring; the ring and central shaft are separated, applying traction to the flanges, via the expansion arms, thereby causing the support arms to pivot, causing the flanges to move away from the central shaft resulting in controlled expansion of the implant. The implant includes a casing enclosing the implant from the proximal to distal end formed by a biocompatible metal alloy sheet, closed on itself in a sealed manner and folded into folds rolled around the longitudinal axis.

The present application relates to the field of surgery, in particular veterinary orthopaedic surgery and in particular to the treatment of a collapsed bone structure by restoring the volume of (or correcting) this bone structure. The present application relates in particular to an implant and to the method for manufacturing it, as well as to a system for restoring bone structure, in particular in the spine for the treatment (often called “reduction”) of compression fractures, in particular vertebral compression fractures (VCFs).

In this field, the problem of restoring the volume of bone structure that has collapsed is well known and the literature contains an abundance of solutions using expandable implants capable of passing from a folded configuration to an expanded deployed configuration to restore the height of the bone structure, preferably in combination with an injection of bone substitute cement, known as cement (or bone cement). Many cements are known and they all have the advantage of being injectable in a liquid or viscous state for a certain period of time, then of hardening (by polymerization) inside the bone structure in order to stabilize it.

A major problem in this field concerns the expansion of the implant to restore height to the damaged bone tissue. Numerous solutions are known from the prior art, such as in particular from patent applications EP3086729, U.S. Pat. No. 11,540,926, EP3747385, EP2572680, EP3958752, EP2693967, EP2405835, U.S. Pat. No. 9,579,130, EP4216836, WO2023122005, WO2022162418, EP3843668 or U.S. Pat. No. 10,945,861 but these solutions present various problems of difficulty of handling for deploying to the expanded state, and of stability and reliability once deployed. Moreover, these known solutions are generally accompanied by an injection of bone cement, but do not provide any teaching relating to cement leakage outside of the implant, whereas such leakage can be detrimental to the surrounding tissue, or even to the entire organism if the chemical substances in the cement get into the bloodstream. In fact, cement generally comprises one or more polymerizable chemical substances, for example such as poly(methyl methacrylate) (PMMA) and possibly additives. In addition, the temperature reached during the polymerization of the cement is not harmless since it is generally greater than 60°.

Devices for the correction and stabilization (or bone fracture reduction), particularly of the spine in the form of a stent, or in the form of porous inflatable bags or of balloons, as in documents EP1408888 or EP1379185, possibly equipped with support flanges as in document US20060100706, are known from the prior art, in particular from documents EP1308134, U.S. Pat. Nos. 9,510,877, 8,936,627 or EP2467099. Numerous documents propose this type of stent, that is to say a deformable endoprosthesis similar to vascular stents, extenders or endoprostheses, which are generally in the form of a meshed tubular body, usually metallic and deformable by the introduction of an inflatable balloon to expand the body by spreading the meshes apart, the balloon then being removed to allow the injection of cement, which hardens and thus forms a correcting and stabilizing structure. However, these devices have the drawback of requiring implantation in two stages: the inflation of the balloon and then the injection of cement, which slows down and complicates the operation and also presents a risk of the device collapsing between the deflation of the balloon and filling of the stent with cement. Furthermore, these solutions have the drawback of not addressing the major problem of cement leaks.

Solutions using implants with a mesh structure, made of shape-memory metal, which is constrained into a folded shape for insertion into the bone tissue and capable of expanding spontaneously, when the stress is released and/or under heat, are also known, in particular from documents EP1938765, EP2351539 or WO200434924. These solutions have the drawback of using expensive alloys and complex manufacturing to obtain an adequate shape memory suitable for the intended implantation, which means additional cost when multiplied by the number of different implants necessary to cover the various pathological cases, in particular by the amplitude of the deformation of which the shape memory material is capable. Moreover, the force exerted by the return of the metal to its unstressed form is often not sufficient to properly correct the bone structure which has collapsed, or is at least a limiting factor. Furthermore, these solutions also have the drawback of not addressing the major problem of cement leaks.

Solutions using expandable implants that can be expanded using a lever mechanism, in the manner of a car jack, to restore the bone structure to a determined height are also known from the prior art, in particular from documents EP2405835, U.S. Pat. No. 9,579,130, EP2572680 or EP1956990. These solutions have the advantage of not risking collapse unlike a stent that is deployed by a balloon which is removed before the injection of the cement, but also have the drawback of implantation in two stages and of the fact that the dimensions of the support surface for exerting the expansion force on the bone tissue are limited, in comparison with stents in particular. Furthermore, they also have the drawback of being expensive and of likewise not addressing the major problem of cement leaks.

The problem of cement leakage has already been identified, in particular in documents EP1408888, EP1509175 or WO200394805, which express the advantages that would be offered by a deformable implant that is not very permeable or that is impermeable, so as to limit or prevent cement leakage. These documents envisage numerous solutions for an expandable implant, made of metal or polymer, which could be either soft and flexible such as a membrane or a fabric, or even elastic, or semi-rigid (“conformable”) or rigid, or made of a shape memory material, with a continuous or fenestrated wall (i.e., mesh) and which could be porous or non-porous. However, all these hypotheses described in these documents define, above all, conceivable treatment methods and objectives to be achieved, without providing any real teaching as regards the technical characteristics or the structural arrangement of the implants, or on how to obtain such implants and thus implement these methods. These proposals therefore present a major problem of technical feasibility.

Furthermore, one problem which is not identified in the prior art concerns the cement injection site and the distribution of the forces exerted on the bone tissues to rectify them. Indeed, the impermeability of an implant makes it possible to avoid cement leaks, but the nature of the impermeable membrane and its technical characteristics such as its physico-chemical and mechanical properties influence its ability to deploy without breaking and to rectify the bone structure. Thus, an elastic membrane has the drawback of deforming excessively in low density zones and thus of having a limited capacity to restore height, with, in addition, the risk of breaking at the points at which its maximum elasticity is exceeded because of this uncontrolled deformation. A semi-rigid membrane is therefore preferable, but this problem of deformation also involves a problem of shapes of the implant, in the folded configuration and especially in the deployed configuration. Indeed, the shape of the deployed implant delimits the cement injection site and the control of this site is important for the distribution of the forces leading to the filling of the low density zones while rectifying the structure (especially in terms of height), and this has an impact on the success of the operation. Thus, it will be understood that the provision of an implant that addresses all of these problems is accompanied by a problem regarding technical feasibility and therefore manufacture.

Other recurring problems in orthopaedic surgery include invasiveness (i.e., the goal of making the smallest possible incision and of minimizing lesions) and also the deployment ratio in order to obtain a deployed implant that fills the largest possible volume while having been introduced through the smallest possible passage. Furthermore, this deployment ratio will have an impact on the distribution of forces for rectifying the vertebrae: if the deformability is too great, the cement-injection pressure will deform the pouch rather than restoring height.

A problem complementary to that of deployment concerns folding, which is generally not possible in implants of the prior art. Control of the folding allows control over the deployment and therefore over the injection site with a uniform distribution of the cement and of the pressure to fill the space to be filled following the collapse. Perfect proportionality suited to the fracture while at the same time respecting the shape of the bone inside the fracture is thus achieved.

In this context, it will be understood that there is still in this field a technical problem concerning the restoration of bone structure (rectification or reduction of fracture or increase in volume after collapse) by means of an expandable (deployable) implant that is able to expand collapsed bone tissue and is impermeable enough to prevent or limit the leakage of cement out of the implant with control of the injection site.

Finally, a main problem that still persists in the field concerns the technical feasibility of manufacturing implants proposed in the prior art. Document WO200394805, for example, describes numerous methods of administering substances and in particular bone cement, with numerous variants envisaged for an expandable implant, made of metal or polymer, which could be either soft and flexible such as a membrane or a fabric, or semi-conformable or rigid, or made of a shape memory material, with a continuous or fenestrated (i.e., meshed) wall and which could be porous or non-porous. However, that document describes only conceivable methods of treatment, but does not provide any teaching as to the technical features, or the structural arrangement of these many hypothetical implants used for these envisaged methods, or on how to obtain such implants and thus actually implement these methods. These proposals therefore present a major problem of technical feasibility and define objectives to be achieved rather than means for achieving them. Moreover, although many objectives have been detailed in the literature, many implants proposed for achieving these objectives have never seen the light of day due to problems of manufacture. In order to address the problem of manufacture, it is necessary to take into account the problems related to the desire to compact/fold a “bag” (balloon/pouch) made of a rigid and impermeable material in order to:
pass through a cylindrical duct;
allow the pouch to expand without rupturing, despite the rigidity and the desired difference in volume between the folded volume and the deployed volume;
control the volume and the distribution of expansion forces on the bone.

In this context, one object of the present invention is to overcome at least certain drawbacks of the prior art by proposing an implant for restoring a collapsed bone structure that is reliable and simple to handle and to implant.

This goal is achieved by an Expandable bone implant for veterinary orthopaedic surgery for restoring the volume and/or geometry of a bone by expansion between a folded configuration and a deployed configuration, said implant comprising a central shaft and extending along a longitudinal axis between a proximal end adapted to cooperate with an implantation instrument for holding the implant and a distal end intended to be first inserted into the bone, at least two faces, for example, an upper and a lower face, of the implant each comprising at least one flange for contact with bone tissue, each of the flanges being supported by at least two support arms each, by means of a hinge on the central shaft and a hinge under the respective flange of each of said support arms; characterized in that:
an expansion ring or socket is arranged on the same axis as said central shaft;
at least two expansion arms each have a hinge connecting them to one of the ends of one of the flanges and a hinge connecting them to said expansion ring or socket;
said expansion ring or socket and the proximal end of the central shaft can be actuated in order to cause separation between said socket and said central shaft, applying traction to the flanges, via the expansion arms, thereby causing said support arms to pivot, thus causing the flanges to move away from the central shaft to result in controlled expansion of the implant between said folded configuration and said deployed configuration; and in that the implant comprises a casing enclosing said implant from the proximal end to the distal end and in that:
said casing is formed by a sheet made of a biocompatible metal alloy, closed on itself in a sealed manner;
said sheet has, at least in the folded configuration, a plurality of pairs of folds, each of the pairs comprising an antiform fold, referred to as convex, and a synform fold, referred to as concave, said folds lying on top of each other in a folded configuration so that the surfaces present between each of said convex and concave folds are rolled around the longitudinal axis;
said proximal end is extended by a sealing sleeve secured in a sealed manner to the lying-down and rolled folds of said sheet over the entire periphery of the proximal end;
said distal end is extended by a socket secured, in a sealed manner, to the lying-down and rolled folds of said sheet over the entire periphery of the distal end of said implant;
said sheet is plastically deformable to allow expansion of the implant from the folded configuration to the deployed configuration, forming a sealed casing enclosing the implant and making it possible to avoid leakage when a fluid is injected into the implant and the casing.

According to another feature, said expansion ring that is able to collaborate with a hollow tube used by said implantation instrument for holding the implant, letting the expansion rod pass through the ring, while the central shaft is able to collaborate with said expansion rod of said instrument so that a pressing force exerted on said expansion rod sliding inside said hollow tube causes said central shaft to move away from said ring, resulting in controlled expansion of the implant dependent on the pressing force exerted on the expansion rod.

According to another feature, the proximal end of the central shaft that is able to collaborate with said hollow tube used by said implantation instrument for holding the implant, whereas said expansion ring or socket is able to collaborate with said expansion rod of said instrument so that a pressing force exerted on said expansion rod sliding inside said hollow tube causes said expansion ring or socket to move away from said central shaft, resulting in controlled expansion of the implant dependent on the pressing force exerted on the expansion rod.

According to another feature, that the central shaft comprises a conduit able to collaborate with said expansion rod which is, on the one hand, hollow and provided with at least one opening at its distal end and, on the other hand, able to be connected to a fluid-injection instrument for conveying at least one fluid to the implant implantation site via the central shaft, and which is preferably provided with openings to disgorge fluid along the length of the central shaft

According to another feature, that the flange-support arms comprise two arms connected respectively near the proximal and distal ends of their respective flange to provide support along the entire length of the flanges and limit the risk of them bowing or sagging.

According to another feature, at least one additional central support arm is connected between a central portion of the central shaft and a central portion of the flanges, with hinges at the two ends of the support arm to allow it to pivot.

According to another feature, the implant comprises two flanges arranged one on each side of the central shaft to provide a bearing surface to bear against the damaged bone tissue on each side of the implant, for example to restore a height or a width.

According to another feature, the implant comprises at least one additional flange, the distribution of the flanges about the central shaft varying according to the number of them and/or according to what is needed in terms of surgical intervention, these preferably being equally angularly distributed radially with respect to the central shaft so as to apply uniform compression to the bone tissue at the periphery of the implant.

According to another feature, the flanges are provided, on their surface in contact with the bone tissue, with irregularities in shape such as protuberances or, conversely, invaginations to improve the grip of the flanges on the bone tissue. Such attachment can be achieved by means of notches, ribs, grooves, straight or curved blades or chevrons, but also spikes, etc.

According to another feature, that the distance between a synform fold and the next antiform fold is longer than the distance between an antiform fold and the next synform fold to make it easier to roll the folds around the longitudinal axis of the implant in the folded configuration.

According to another feature, the sealing sleeve extends the proximal end, parallel to the longitudinal axis, to a distance that is greater than or equal to the distance that the flanges extend from the center of the implant.

According to another feature, said sealing sleeve extends said proximal end, parallel to the longitudinal axis, to a distance that is greater than or equal to that to which the flanges extend from the centre of the implant

According to another feature, said sealing sleeve has a through-opening of which the diameter is greater than or equal to that of the opening of the sliding sleeve, so that these two sleeves, the sealing sleeve and the sliding sleeve, form an entrance to the inside of the hollow body of the implant from a conduit of an implantation instrument holding the implant at the proximal end, able to convey a fluid that is to be injected into said implant.

According to another feature, the implant comprises, in the deployed position, a middle portion between its two ends that has the shape of a generalized cylinder of a length greater than or equal to that of the flanges, with possible and partial persistence of said folds, said middle portion being extended, at the end corresponding to the proximal end, by a frustoconical portion connecting the middle portion to the sleeve and, at the end corresponding to the distal end, by a frustoconical portion connecting the middle portion to the socket, the frustoconical portions having a permanent persistence of at least part of the lying-down and rolled folds near the proximal end and distal end

According to another feature, that said sheet is plastically deformable also from the folded configuration to the deployed position, in particular as a result of the persistence of the lying-down and rolled folds at the proximal and distal ends, enhancing the reversibility of the expansion.

According to another feature, said central shaft is able to collaborate with and/or is extended beyond the distal end of an implantation instrument at the proximal end of the implant and having an interior conduit in communication with a conduit formed in said central shaft and opening onto the space formed by the parting of the flanges, via at least one opening allowing said fluid to be injected into the implant.

According to another feature, that said sheet is secured at the proximal end by welding that fixes the proximal end of the lying-down and rolled folds against the exterior wall of said sliding sleeve, whereas the distal end of the sheet is either closed on itself with its lying-down and rolled folds compressed in contact with one another and secured to one another by a weld that forms a distal closure, or secured at the distal end by welding that fixes the distal end of the lying-down and rolled folds against the exterior wall of said pull-socket.

According to another feature, said sheet is compressed around the sleeve of the proximal end and/or around the socket of the distal end by a compression ring that holds the lying-down and rolled folds against the exterior wall of said sleeve and/or of said socket.

According to another feature, the folds are, at least in the folded configuration, parallel to the longitudinal axis.

According to another feature, the sheet also comprises at least one pair of folds (a synform fold and an antiform fold) of axis not parallel to the longitudinal axis, preferably perpendicular so that the implant can expand also lengthwise, or oblique so that the implant can expand in a curved manner.

According to another feature, the number of pairs of folds is comprised between 3 and 16, generally 4 to 12, and preferably of the order of 8.

According to another feature, that the sheet has a thickness comprised between 3 and 100 microns, generally between 6 and 50, and preferably 10 and 30 microns.

According to another feature, the sheet is made of a titanium alloy.

According to another feature, the distance between the folds is variable for one lateral face of the implant to the other, so that the shape of the implant in the deployed configuration is curved and/or asymmetric transversely to the longitudinal axis.

Another purpose of the present application is to overcome at least some of the disadvantages of the prior art by proposing a surgical intervention system that is easy to use and allows effective stabilization of bone tissue.

This purpose is achieved by a System for orthopaedic treatment of damaged bone tissue, comprising a bone substitute cement and at least one instrument for implantation and for injection of cement into the implant

According to another feature, the instrument for implantation and for injection of cement comprises means for controlling the pressure and/or the aspiration of the cement so that the implant can be re-folded to the folded configuration if necessary.

According to another feature, that the implantation instrument is distinct from but complements the injection instrument the cement-injection canal of which passes through a canal inside the rod of the implantation instrument that via its distal end holds the proximal end of the implant.

According to another feature, method for manufacturing an implant, characterized in that it comprises
Obtaining an expandable implant with two flanges that can be parted under the effect of the ends of the implant being moved closer together by support arms that connect these ends to the flanges;
Closing the sheet on itself and welding it to form a generalized cylinder;
Inserting the closed sheet on a die in the shape of a generalized cylinder having a star-shaped base and referred to as a star-shaped rod, the number of branches of the star defining the number of pairs of folds of said sheet of said implant;
Compressing the closed-up sheet between said die and a plurality of projecting elements of a shape that complements the hollows between the branches of the star;
Rolling the folds of said sheet around the longitudinal axis,
Inserting said expandable implant inside said compressed sheet;
Securing said sheet to the socket and the sleeve.

Other features and advantages of the present invention will become more clearly apparent on reading the following description of various embodiments, with reference to the appended drawings, in which:

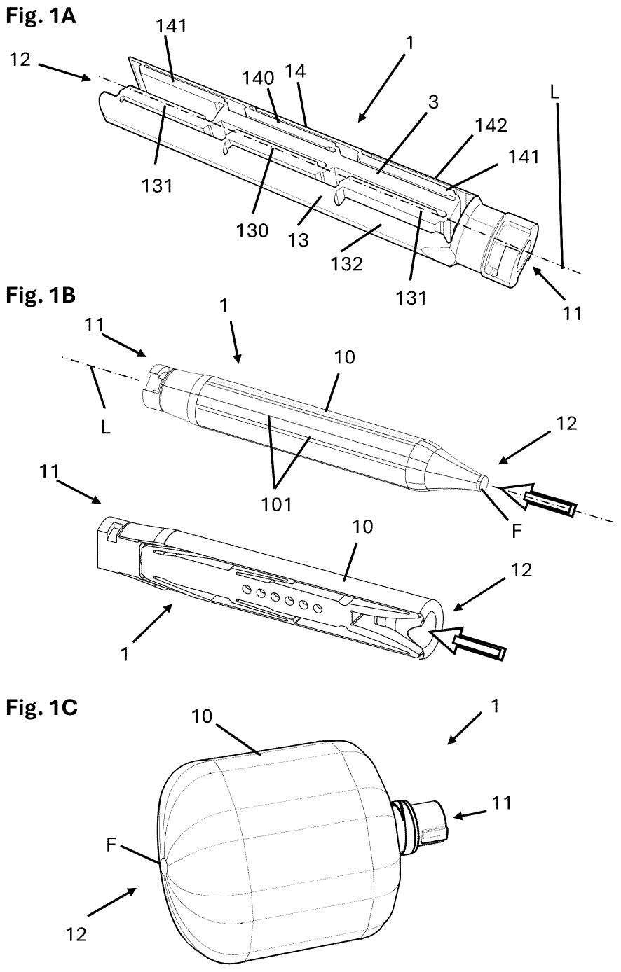

FIG. 1A depicts a perspective view of an expandable implant according to a certain embodiment, without its casing, FIG. 1B depicts a perspective view of an implant fitted with its casing prior to the folding of the distal end of the casing and after the folding of this distal end, and FIG. 1C depicts a perspective view of the implant of FIG. 1B but in the deployed configuration;

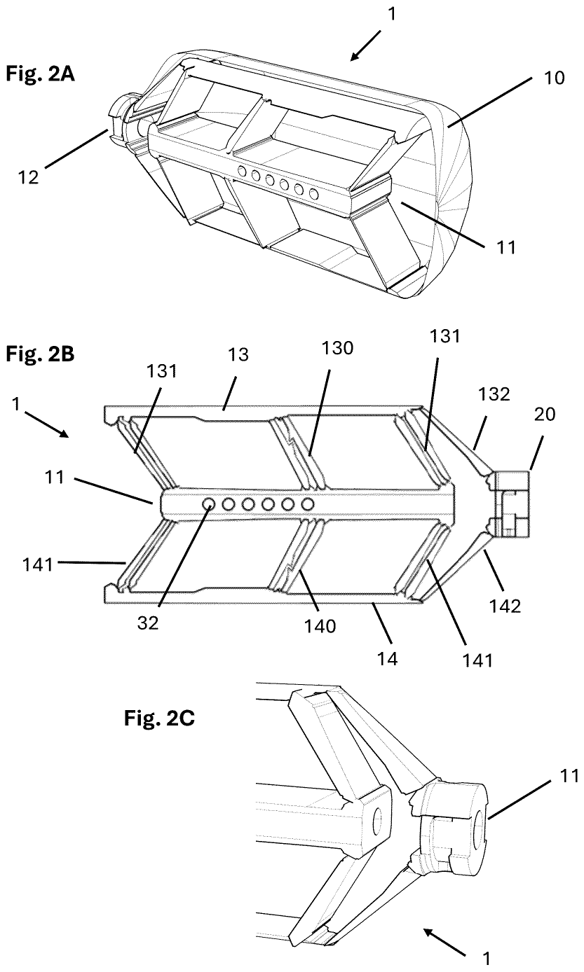

FIG. 2A depicts a perspective view of an implant of the same type as FIG. 1C but with the casing sectioned in its middle part, FIG. 2B depicts a profile view of an expandable implant in the deployed configuration equipped with double support arms and having a self-locking mechanism, and FIG. 2C depicts a detail of the proximal end of an implant according to various embodiments;

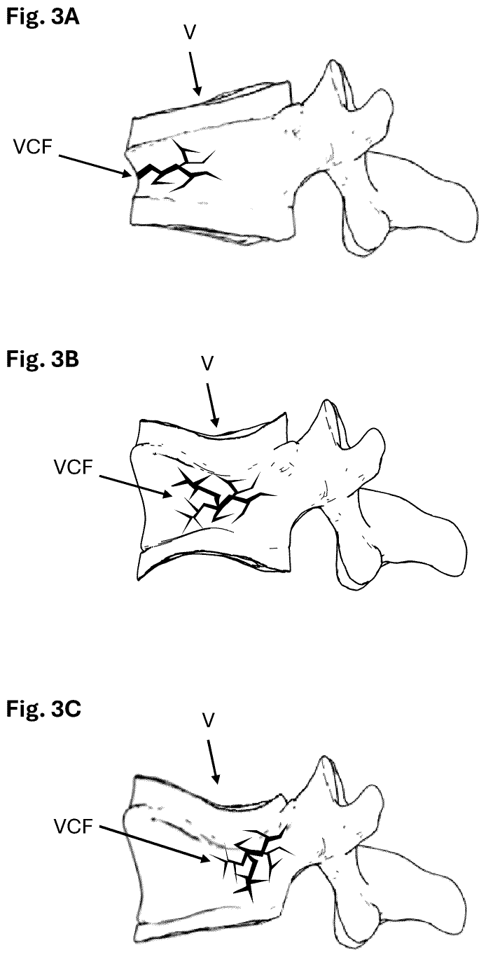

FIGS. 3A, 3B and 3C depict profile views of vertebrae that have respectively suffered anterior, median and posterior vertebral compression fractures (VCFs);

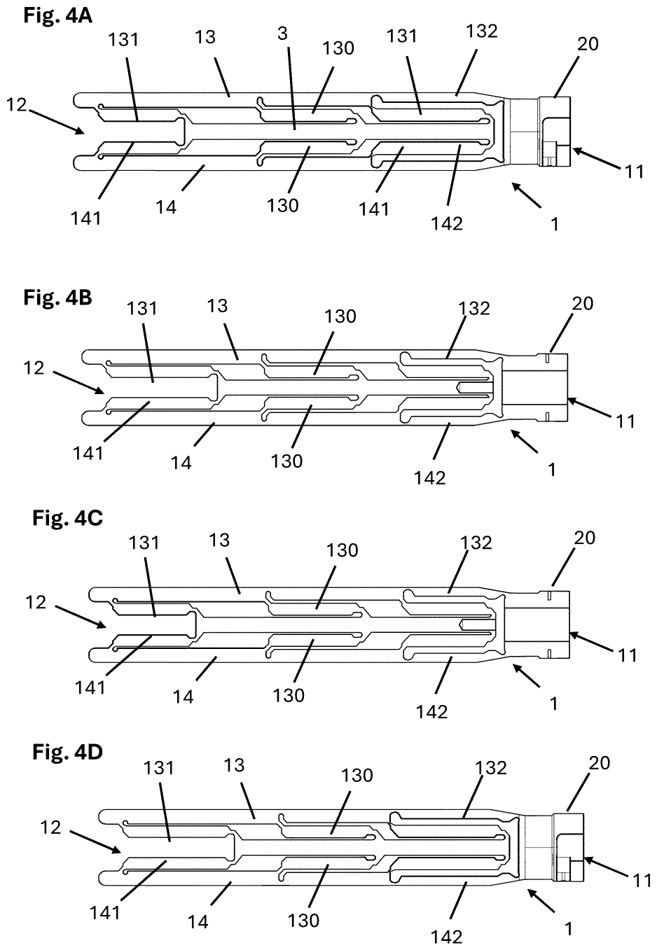

FIGS. 4A, 4B, 4C and 4D depict profile views of four expandable implants in the folded configuration according to different embodiments, with support arms of different lengths;

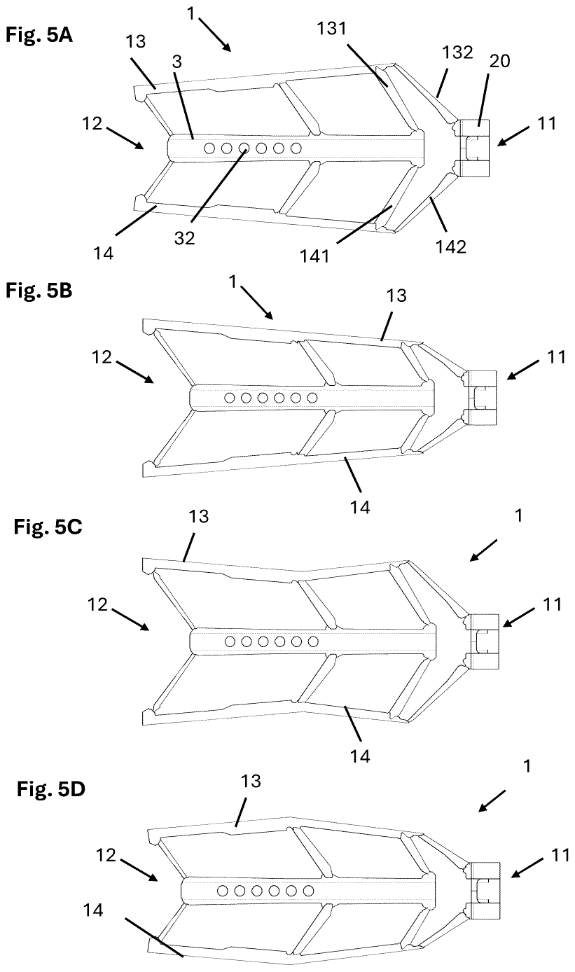

FIGS. 5A, 5B, 5C and 5D depict profile views of the implants of FIGS. 4A, 4B, 4C and 4D, respectively, but in the deployed configuration with their flanges non-parallel;

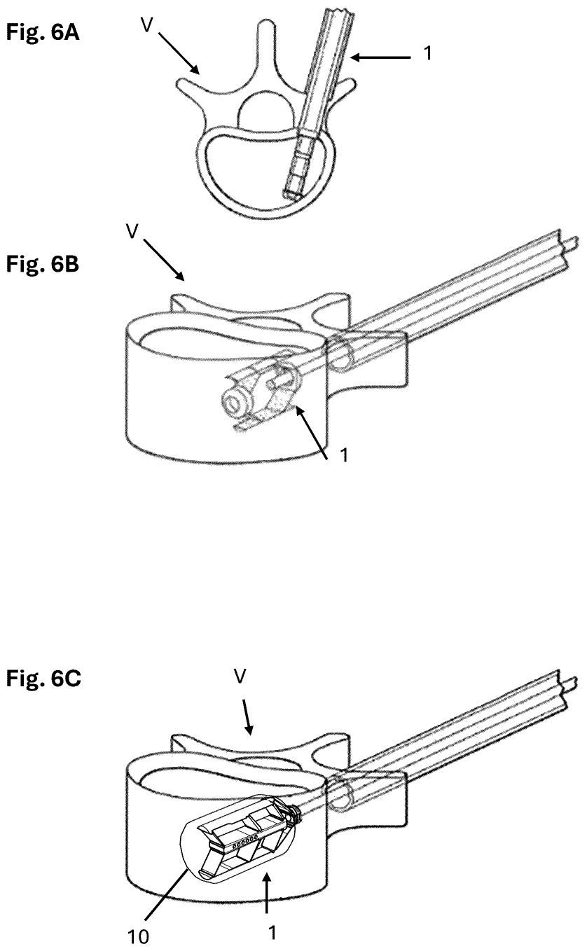

FIG. 6A depicts a view from above of a vertebra in which an implant according to various embodiments is implanted, FIG. 6B depicts a perspective view of a vertebra in which an implant of the prior art is implanted, and FIG. 6C depicts a perspective view of a vertebra in which an implant according to certain embodiments is implanted;

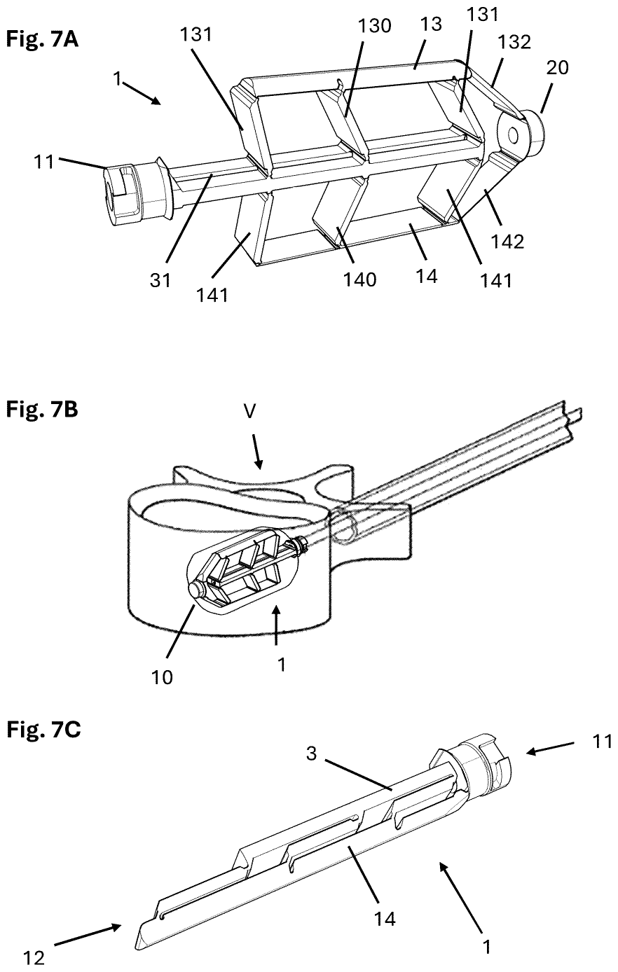

FIG. 7A depicts a perspective view of an expandable implant according to one of certain inverted embodiments, FIG. 7B depicts a perspective view of a vertebra in which the implant of FIG. 7A is implanted, using an instrument and FIG. 7C depicts a perspective view of an implant with a single side flange for expansion on only one side of the implant, according to some embodiments;

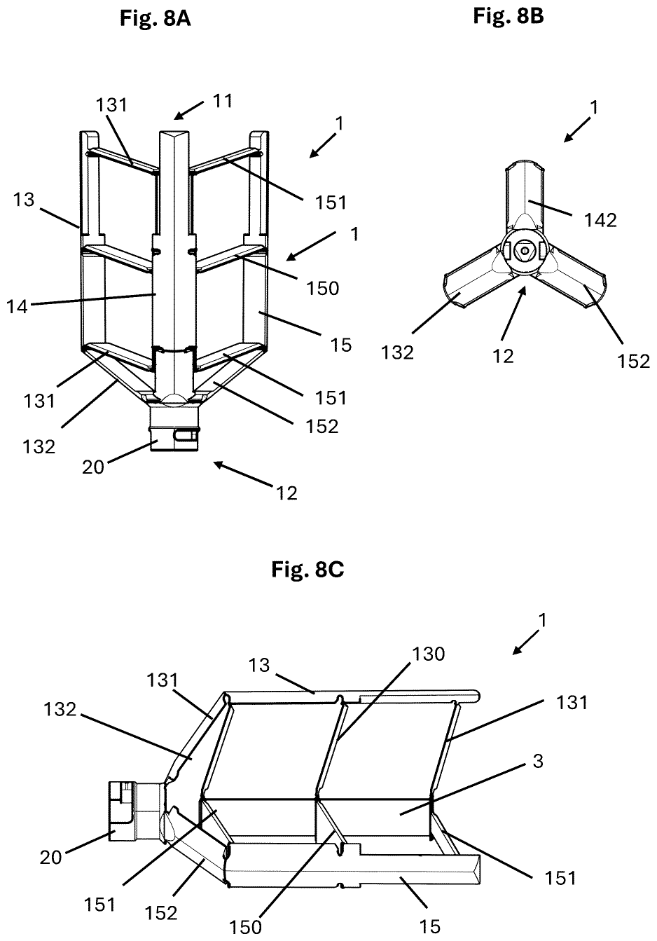

FIGS. 8A, 8B and 8C depict, respectively, a view from above, a face-on view of the profile view of an expandable implant with three flanges according to certain embodiments;

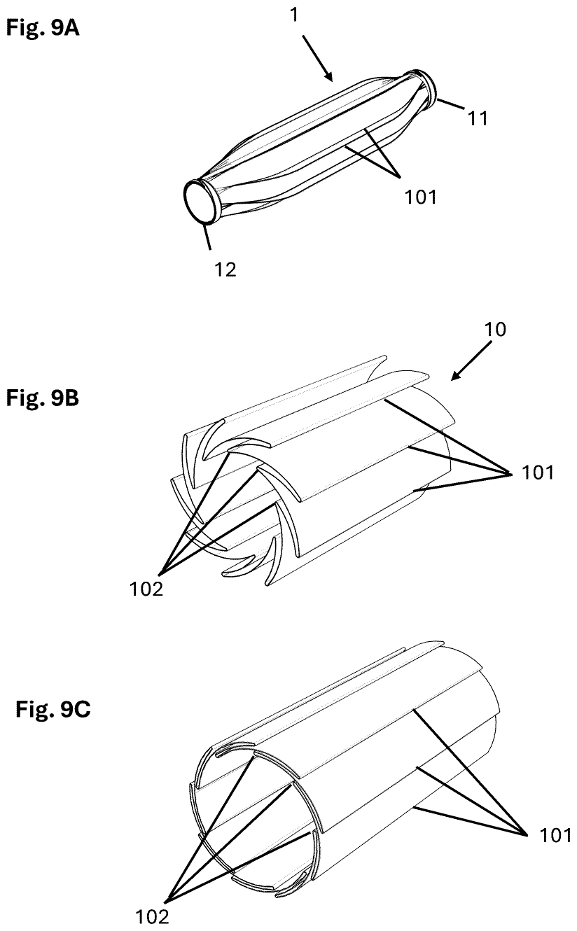

FIG. 9A depicts a perspective view of an expandable implant in a semi-deployed configuration, according to certain embodiments, FIG. 9B depicts a perspective view of a sheet used for the manufacture of an expandable implant according to certain embodiments in the semi-folded configuration, and FIG. 9C depicts a perspective view of this same sheet in the folded configuration;

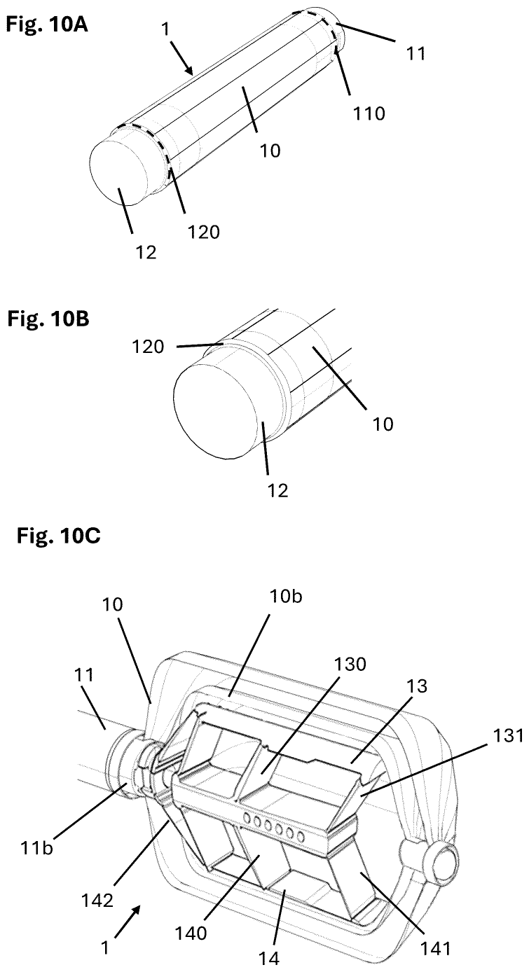

FIG. 10A depicts a perspective view of an expandable implant in the folded configuration with lines of welding at the proximal and distal ends, FIG. 10B depicts an enlargement of FIG. 10A at the distal end and FIG. 10C a perspective view of an implant, as if sectioned through its middle part for illustration purpose (as in FIG. 2A), but comprising a second sheet surrounding the first sheet to form a double casing, according to some embodiments;

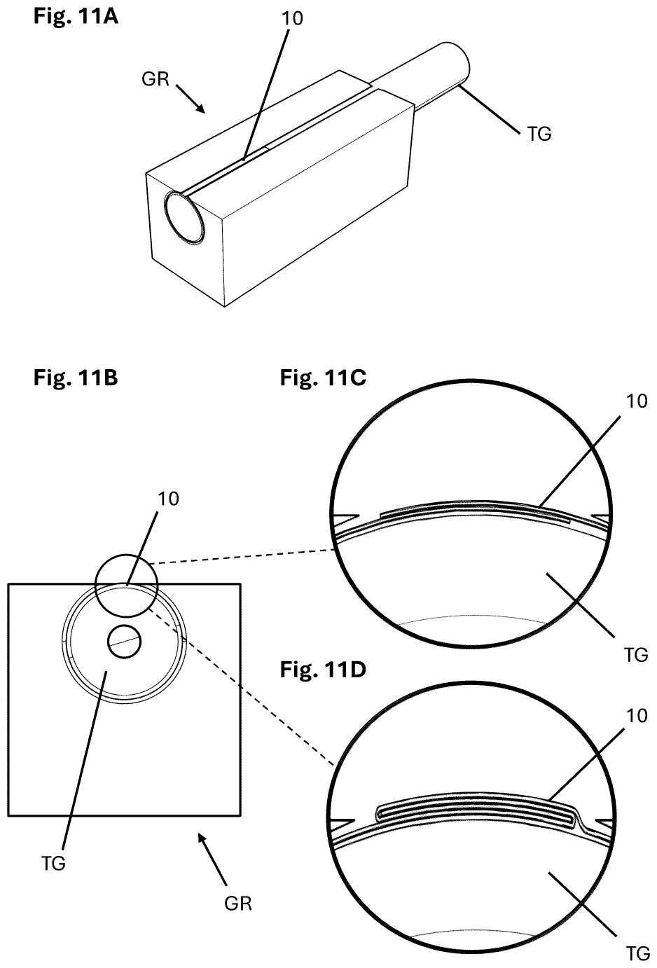

FIGS. 11A and 11B depict a perspective view and a profile view, respectively, of a guide tool that guides the folding of a sheet of an expandable implant according to certain embodiments guided by means of a guide tube and FIGS. 11C and 11D show enlarged views of the view of FIG. 11B but for two different embodiments of the sheet's closure;

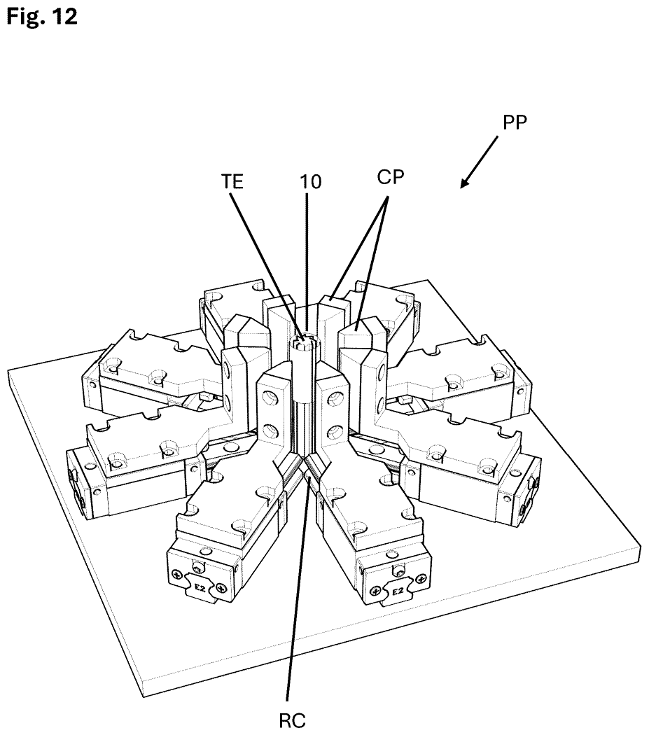

FIG. 12 depicts a perspective view of a tool having pre-folding cams and a star-shaped rod, for the pre-folding of sheets for implants, according to various embodiments;

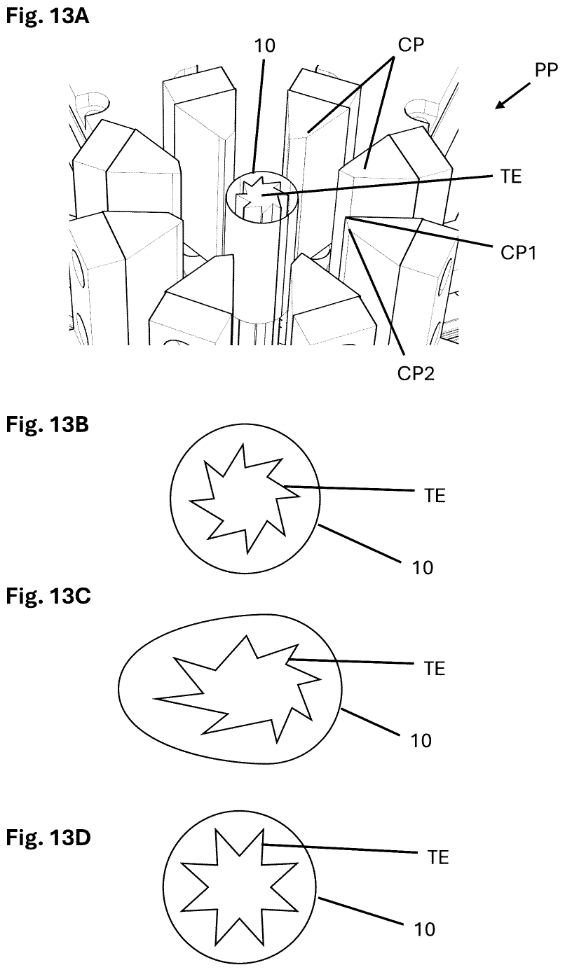

FIG. 13A depicts an enlargement of FIG. 12, FIGS. 13B, 13C and 13D depict the views from above of various embodiments of the pre-folding tool with its star-shaped rod and the sheet of the implant slipped around it;

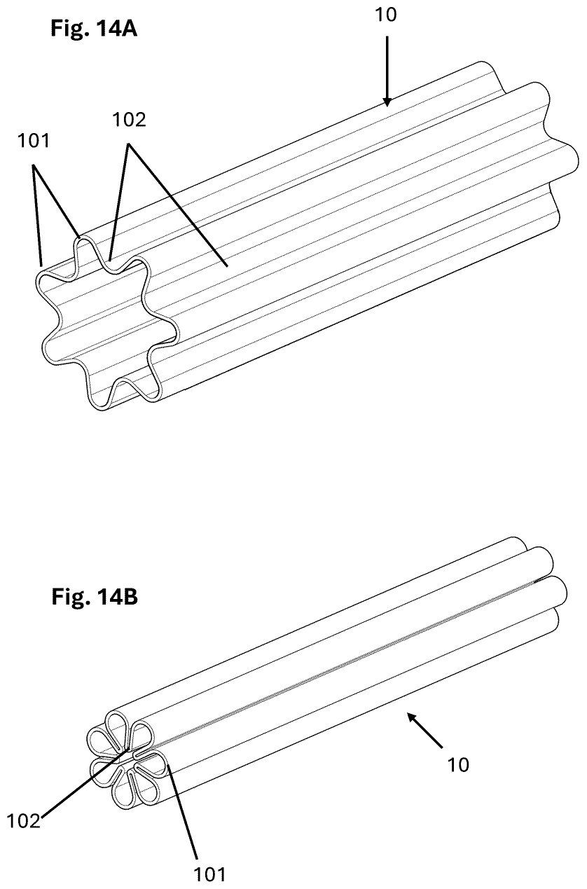

FIG. 14A depicts a perspective view of a sheet that has been pre-folded using a star-shaped rod such as that of FIG. 13D, and FIG. 14B depicts this same sheet folded on itself, according to certain embodiments, FIG. 14A depicting a view from above of a vertebra in which an implant is being implanted according to various embodiments;

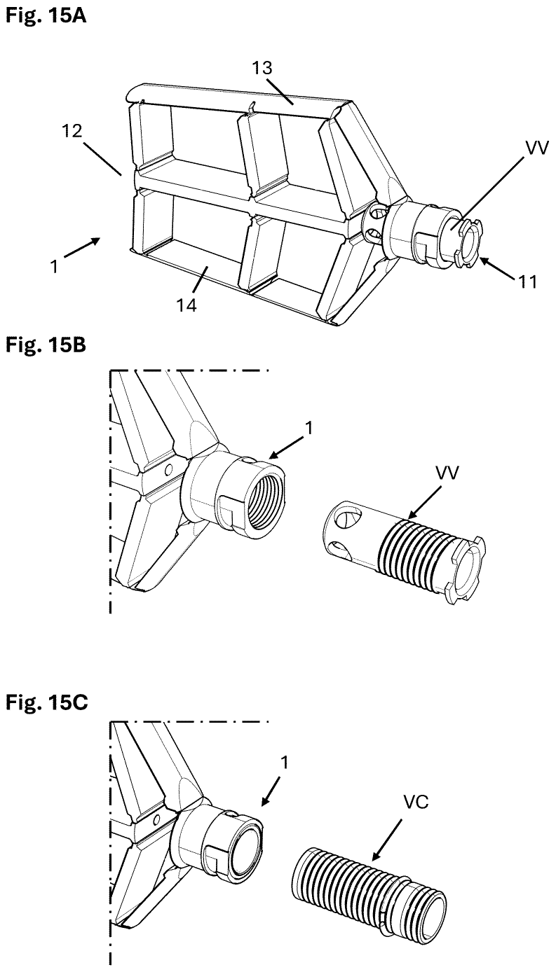

FIG. 15A depicts a perspective view of an expandable implant in the deployed position and equipped with a lock that holds the implant in its deployed configuration, FIG. 15B depicts a detail of the proximal end of an implant of the type of FIG. 15A, with the lock on the outside of the implant according to certain embodiments, and FIG. 15C depicts a detail of the proximal end of an implant according to certain embodiments with another type of lock on the outside of the implant.

The present application relates to an implant and an orthopaedic surgery system for treating fractures in bone and bone tissue in general, and to a method for manufacturing the implant. The bone implant is preferably a spinal implant, and in particular a vertebral or even in fact intervertebral implant, although other uses elsewhere than in the spine (intervertebral discs) or in other bony structures where it is necessary to fill a space left vacant as the result of a fracture (the causes of which may be various, even though they generally imply a reduction in bone density) are conceivable. Thus, vertebral compression fractures (VCFs) are a favourite application but are not the only conditions that can be treated using the present invention, and the person skilled in the art will appreciate the possibilities offered without requiring further details here. By way of other bones, mention may be made of the femur or the humerus (head), for example in the event of risk of collapse. This application relates to an implant and a veterinary orthopedic surgery system for treating fractured bones and bone tissue in general, as well as a method for manufacturing the implant. The bone implant is preferably a spinal implant, and in particular a vertebral or even intravertebral implant, but other uses are possible elsewhere in the spine (intervertebral spines) or in other bone structures where it is necessary to fill a space left by a fracture (the causes of which may vary, although they generally involve a decrease in bone density). Thus, vertebral compression fractures (VCFs) are a favorite application, but they are not the only ones that can be treated with the present invention, and those skilled in the art will appreciate the possibilities offered without further detail here. Other bones include the femur or humerus (head), for example, in cases where there is a risk of collapse. In the veterinary field, it is known that animals sometimes have bone densities that are very different from those of humans and, above all, vary greatly depending on the species and even on the breed or animals within the same species, particularly in the case of dogs, whose physical properties vary enormously from one breed to another. For example, dachshunds and similar breeds have long (tall) vertebrae but are not very wide compared to other species. It is therefore useful to have expandable implants that allow for significant expansion in height while having a reduced length, and it is clearly necessary to take into account the differences in the shapes and sizes of the bones of different species in order to adapt the therapy effectively with suitable implants. In addition, some species, such as cats, have very rigid cortical bone but more flexible cancellous tissue than other species. It is therefore also necessary to take into account the nature of the bone tissue. Finally, another notable example concerns horses, which have bones, particularly vertebrae, with a specific anatomical shape and which sometimes bear a heavy load. Depending on the activity (e.g., sports) and morphology, bone density varies and implants must be adapted to allow for expansion but also to bear loads. Thus, for a horse, it may be necessary to have implants with more load-bearing arms (at least 3 or 4) than for other species (where 2 support arms are sometimes sufficient). In the absence of support arms, the implant must have sufficient mechanical strength, thanks to its ability to withstand higher cement pressure than in other cases.

In addition, the tibial plateau is frequently subject to crushing, and the implants or systems of the present application are useful for restoring height in any type of bone crushing or collapse, for example in the distal part of the humerus or femur. On the other hand, as taught, for example, in document EP2921142, it is possible to use expandable implants as bone anchoring implants, and such use is also possible for implants such as those of the present application. In this case, the implants will be extended at their proximal end by an elongated body to which another orthopedic implant of another type or a surgical device for fixing other elements can be attached. Nevertheless, in the case of use as a bone anchor in a vascularized structure, such as a humeral or femoral head, the size of the implant will preferably be limited in relation to the bone structure in order to preserve vascularization and promote bone healing.

Certain embodiments comprising more than two flanges may notably prove more effective in the treatment of long bones of this type by distributing the forces of expansion over more than two surfaces, thereby providing better stability regardless of the type of bone.

Furthermore, in various embodiments that do not necessarily relate to long bones, the implant comprises distal-end support arms that have a length different from that of the proximal-end support arms and/or of the central support arms, so that the implant in the deployed configuration has flanges that are not parallel to one another. Illustrative and nonlimiting examples of such embodiments are depicted in FIGS. 4A, 4B, 4C and 4D in the folded configuration and in FIGS. 5A, 5B, 5C and 5D corresponding to their respective deployed configurations. It will be appreciated that longer arms at the proximal end (FIGS. 4A and 5A) make it possible to obtain flanges that are inclined towards the distal end, whereas longer arms at the distal end (FIGS. 4B and 5B) make it possible to obtain flanges that are inclined towards the proximal end. In addition, it is possible to provide flanges that do not remain flat at the end of expansion, this representing a marked advantage of the implant which is then able to conform to the anatomical shapes of the bones in which they are implanted. Thus, a concave or bi-concave shape (concave on both faces of the flanges) of the deployed implant can be obtained with central arms (130, 140) that are shorter than the support arms (131, 141), as in FIGS. 4C and 5C, whereas a convex (or bi-convex shape which is convex on both faces of the flanges), can be obtained with central arms (130, 140) that are longer than the support arms (131, 141), as in FIGS. 4D and 5D.

Certain embodiments provide for the injection of a fluid (e.g. “bone cement”, generally based on a polymer such as PMMA for example and well known to those skilled in the art such that no detail on the cement will be given here). Thus, once positioned, the implant may notably be stabilized by such an injection of cement. However, because cement leakages remain a major problem in this field, various embodiments propose the containment of the cement in a fluidtight casing of which the post-injection volume can be controlled through the structure and material of the casing, according to the injected pressure (and the configuration of the bone tissue, preferably assessed in advance, as is the general practice in this field). Fluidtightness is of course relative and this term is not limiting either, since the level of fluidtightness is in fact adapted to the viscosity of the cement at the moment of its injection. Certain embodiments in particular allow a proportional expansion of the casing as a result of the (relative) flexibility of the sheet (10) of biocompatible metallic material. This material is generally a titanium alloy obtained in the form of a very thin sheet, preferably by rolling to give a controlled surface condition and a controlled thickness, notably a thickness comprised between 3 and 100 microns, generally between 6 and 50 and preferably 10 and 30 microns. In general, the present invention uses at least one sheet (10) of biocompatible metal or biocompatible metal alloy, such as titanium or its alloys, particularly with nickel or others, but also nitinol or stainless steel or their alloys. Advantage is taken of recent techniques for obtaining very thin sheets of such metals, in particular with a thickness of less than 50 or even 40 μm, which makes it possible to obtain relatively flexible and elastic sheets, but above all, which can be plastically deformed in a reversible manner without reaching their tear limit, by creating folds arranged longitudinally on the implant. In particular, it is possible to provide a maximum deployed volume that is greater than the volume required for the desired applications, so that this limit is never reached and it is possible to fold and then redeploy the implant, even several times (for example, in the event of incorrect positioning of the implant) without the risk of tearing and uncontrolled leakage. Thus, thanks to this type of sheet and the configuration of their interlocking folds, it is possible to obtain expansion ratios between the folded volume and the deployed volume ranging from 2 to 20, or even 30, and it is also possible to control the shape of the implant in the deployed configuration, depending on the arrangement of the folds, in the manner of origami. Finally, although one of the main goals here is to prevent cement leakage, it can sometimes be useful to control the release of cement outside the implant, so that it is no longer a question of leakage but of controlled release, for example to allow adhesion to certain surrounding structures (usually bone structures). Similarly, since the injected fluid is not necessarily cement (or at least not the fluid that would come out of the implant), it may in fact be useful to administer molecules through such controlled release of this fluid. Thus, various embodiments provide for a certain porosity of the sheets (10) at least in certain portions of the implant, for example through holes of controlled microscopic size and controlled number and density. In any case, this sheet is capable of reversible plastic deformation a number of times that is satisfactory for the target application since it notably offers the possibility of retracting the casing formed by the sheet in the event of a problem (biocompatibility and resistance to tearing). Specifically, in general, controlling the metering of the cement allows monitoring for the fifteen minutes of polymerization time during which it is possible to retract the casing and aspirate the cement. Furthermore, through the injection of cement and the expansion of the casing, the implant fills the spaces in the damaged tissues according to the compression and bone-resistance forces relative to the hydraulic pressure supplied during the injection of cement. From such a sheet, it is necessary to obtain a closed structure, which already means that the sheet needs to be closed on itself and locked in position. To do that, welding (or bonding or brazing, these terms being nonlimiting here) may be used to join together two superposed edges or edges with interlocking turn-ups, to facilitate the welding and make it more robust. Certain embodiments therefore envisage closure by welding from the outside, which is simpler and more robust because of the superposition of layers at these complementary folds.

The term “secured” here means the two elements are secured to one another, either permanently (or near-permanently) but also sometimes that a connection is made so that one element can be actuated by another. Thus, screw-fastening or collaboration between shapes for temporarily locking the elements together are covered by this nonlimiting term.

The terms “ring”, “sleeve”, or “tube” refer to hollow structures such as bands, conduits or pipes, but nonlimitingly, notably having various shapes (on the inside as on the outside), although a cylindrical shape is preferred. The term “canal” by contrast is preferably used here to refer to a passage rather than to the element that contains it, and the term “opening” here refers to the fact that an element is open and able to be passed through, opening out into another structure or another element. In general, the terms “sleeve”, “tube” or “conduit” refer to longer elements than rings or bands, although their use here is likewise nonlimiting. Furthermore, the terms “socket” or “cup” refer also to hollow structures that are open at one end but closed at the other end, such as plugs, closures, constrictions or restrictions, and these terms are used indiscriminately without any limitation.

The term “hinge” is used here in its functional sense without implying any structural limitation, and may in fact refer to mechanical hinges even though these are preferably formed (as illustrated in the nonlimiting examples in the figures) by thinning (or narrowing, removing material from) elements such as the support arms or other elements. Thus, a hinge is in fact an articulation point or region since it is known in the art that there is generally no danger associated with providing such pivot mechanisms in implants because the materials of which they are made are suited to this type of articulation. It will be noted that thinnings of the flanges are also conceivable, notably next to the articulations (hinges) of the support arms, so as to allow the flange to conform to the desired morphological shape, notably when the support arms do not have the same length as each other. The terms “cylinder”, “cylindrical” or “generalized cylinder” are used in the present application indiscriminately to make the invention easier to explain and in fact all refer to a “generalized cylinder”, which is to say a three-dimensional shape defined by a height (parallel to the longitudinal axis) and two bases (transverse to the longitudinal axis) which may have any shape whatever, even though a circular shape is preferred in order to simplify the manufacture and limit the risk of lesion of the tissue into which it is introduced. Preferably, this “cylinder” is a right cylinder, which is to say that its bases are aligned with respect to the generatrix (or height) of the cylinder. Furthermore, because the implant may deploy in a tissue to conform to the shape of the space into which it has been introduced (modifying this thanks to the pressure it exerts on this tissue), it is possible for the shape not to be constant so the two bases of the cylinder may have different shapes (areas).

As a result, the term “diameter” is used, in the present application, to refer in fact to the longest dimension of the generalized cylinder transverse to the height (or longitudinal axis) thereof, namely in a plane (referred to as “transverse”) parallel to that of the bases of such a generalized cylinder. Thus, the term “diameter” may in fact refer to the length of the diagonal of a square or of a rectangle or else (for any arbitrary shape) to the longest distance between two points included in such a transverse plane and lying on the circumference of such a cylinder. Likewise, the terms “circumference”, “periphery” or “perimeter” are used here to refer to the perimeter of these bases of any arbitrary shape.

Likewise, the terms “conical” or “frustoconical” are used here to denote shapes that widen from a minimum “diameter” (or surface-area/surface) up to a maximum “diameter”, but they do not imply any limitation as to the shape of the parameter which may or may not be circular.

The terms “antiform fold”, referred to as “convex”, and “synform fold”, referred to as “concave”, are used by analogy with the definitions of folds in numerous technical fields, including that of geology, but it will be appreciated that “convexity” is defined here with respect to the outside of the implant. An antiform or convex fold is therefore a fold that turns the material inwards, while an antiform fold turns the material outwards. The succession of the two types of folds makes it possible to limit as far as possible the volume that is folded. In addition, certain embodiments envision a succession of long folds and of short folds making rolling and/or compaction easier by limiting the extent to which material is superposed in the folded configuration. To make it easier to roll the sheet (10) on itself and obtain a smaller folded volume, it is preferable to envisage an alternation of long folds and short folds. To do that, it is possible to use pre-folding cams (CP) having two edges at different angles, with a star-shaped rod (TE) likewise of asymmetric shape complementing the first angle (CP1) of the pre-folding cam and the second angle (CP2) of the pre-folding cam, as for example depicted in FIGS. 12, 13A, 13B and 13C, but it is also possible to have pre-folding in a symmetrical shape, as for example depicted in FIGS. 13D, 14A and 14B, although these embodiments gave less-advantageous folding than asymmetric folding with an alternation of long folds and short folds.

In general, it is understood that the implant will retain, even in the deployed configuration, at least some of the folds lying flat and rolled up near the proximal and distal ends, but the dimensions and strength properties of the sheet (10) used allow the implant to be obtained and these persistent folds do not interfere with function and do not cause mechanical or physiological problems in the bone tissue. In certain embodiments, the implant comprises, in the deployed position, a median portion between its two ends which has a generalized cylindrical shape, with possible and partial persistence of said folds, said median portion extending, on the proximal end side (11), by a truncated cone portion connecting the median portion to said sleeve and, on the proximal end side (12), by a truncated cone-shaped portion connecting the middle portion to said sleeve, the truncated cone-shaped portions having a permanent persistence of at least a portion of folds lying flat and rolled up near the proximal (11) and distal (12) ends.

It will also be noted that the number of folds is not limiting either but that rather makes it possible to maintain the irregularity or trueness of shape of the implant as it deploys, this likewise offering advantages notably in terms of stabilization. In addition, it is still preferable to have an even distribution of surface areas between the folds for uniform deployment allowing uniform deployment, although the invention also envisions other applications and notably folds of different sizes depending on the region of the implant, so as to obtain asymmetric deployment and better therapeutic outcomes. Moreover, the present invention makes it possible to control the shape of the implant once deployed by also setting the distance between the folds. Specifically, the distance between the synform/antiform folds, and therefore the distance between the long folds and the short folds, governs the way in which it deploys. Advantageously, if the density is greater at one point on the periphery, deployment will be greater and if it is lower, the casing will be able to deploy to a lesser extent. It will be appreciated that asymmetry and curving is thus obtained by more extensive deployment in regions that have the greatest folds content. Likewise, it is possible to envisage more material (a larger surface area of sheet) on one side for example so the lateral expansion will be greater on this side than on the other. Moreover, in certain embodiments, the sheet is welded to the flanges and is therefore unable to deploy further than the distance between the flanges, which distance will have been set by the lever mechanism. What is thus obtained is an implant the expansion of which is limited in one dimension (in general the essential dimension in which a precise height or width is to be restored) but not in another dimension, so that the injection of cement will deploy the casing into the volumes of low bone density that may be present around the implant. It will also be noted that the fluid injection instrument (Ac) may be fitted with means for controlling the injected pressure (a pressure gauge for example) and for indicating the resulting volume so that the expansion into the bony tissue can be controlled effectively.

Finally, it will be appreciated that the instrumentation proposed in the present application in certain embodiments, using an implant holder (or ancillary) of relatively conventional type to hold the implant and introduce it into the bony tissue, but also of less-conventional type for expanding it into the bony tissue, also offers the advantage that all the implantation and stabilization steps can be carried out using just one single instrument and in a continuous operation. Specifically, the ancillary with a hollow tube for conveying cement through the tube that holds the cement makes it possible to offer an instrument that allows the surgical intervention to be performed quickly and efficiently. After drilling, the implant is introduced and, without withdrawing the instrument, the casing can be inflated with the cement and then the tool can be withdrawn before, during or even after the polymerization of the cement (for example using a mechanism for cutting the hardened cement as the instrument rotates). The time taken to perform the surgical operation is of course markedly reduced as also the stability of the implant which is not released at any time until it has been stabilized by the injection of cement filling all the free volumes around it, unlike in certain solutions of the prior art.

In general, the present application relates to an expandable bone implant (1) for veterinary orthopaedic surgery for restoring the volume and/or geometry of a bone by expansion between a folded configuration and a deployed configuration, said implant comprising a central shaft (3) and extending along a longitudinal axis (L) between a proximal end (11) adapted to cooperate with an implantation instrument (A) for holding the implant and a distal end (12) intended to be first inserted into the bone, at least two faces, for example, an upper and a lower face, of the implant each comprising at least one flange (13, 14, 15) for contact with bone tissue, each of the flanges being supported by at least two support arms (131, 141, 151) each, by means of a hinge on the central shaft (3) and a hinge under the respective flange (13, 14, 15) of each of said support arms (131, 141, 151); characterized in that:
an expansion ring or socket (20) is arranged on the same axis as said central shaft (3);
at least two expansion arms (132, 142, 152) each have a hinge connecting them to one of the ends of one of the flanges (13, 14, 15) and a hinge connecting them to said expansion ring or socket (20);
said expansion ring or socket (20) and the proximal end of the central shaft (3) are able to be actuated in order to cause separation between said socket (20) and said central shaft (3), applying traction to the flanges (13, 14, 15), via the expansion arms (132, 142, 152), thereby causing said support arms (131, 141, 151) to pivot, thus causing the flanges (13, 14, 15) to move away from the central shaft (3) to result in controlled expansion of the implant (1) between said folded configuration and said deployed configuration. Actuation of the ring or socket (20) and the central shaft (3) is preferably obtained through the fact that these are able to collaborate, respectively or vice versa, with a hollow tube (A1) used by an implantation instrument (A) for holding the implant (1), and with an expansion rod (A3) of said instrument (A), this expansion rod (A3) being able to slide inside said hollow tube (A1) to move said socket (20) and said central shaft (3) away from each other.

It will be appreciated that, unlike in certain implants of the prior art in which the structure used for expansion (often with a pull-shaft) that enables two ends of the implant to be brought closer together and the support arms to be brought closer together, the implants of the present application are deployed without bringing the support arms closer together, thereby avoiding the need to apply two mutually opposing forces to the same elements, since the force exerted on the expansion arms (132, 142, 152) enables the support arms (131, 141, 151) to be made to pivot in the same direction, thereby limiting the stresses applied to the structures and thus making deployment easier and also preserving these structures and therefore improving the reliability of the implant.

It will be noted that the implant comprises at least one flange and that it is therefore possible to have a single flange for expansion on just one side, for example as depicted in FIG. 7C, as known in the prior art for deployable implants comprising other deployment mechanisms such as those above with support arms that move closer together.

It will be noted that the term “central reinforcement” is used to refer to a central shaft on which the deployment support arms are articulated to one another. The implant flanges to which the support arms are articulated are also articulated to this shaft, which therefore acts as a reinforcement but mainly as a support for expansion because it supports the articulations or hinges of one of the flanges. Furthermore, it will be noted that the expansion (i.e. support) arms are advantageously connected to the flange directly so that the force of expansion of the implant can be applied and the flanges parted directly by direct action on these flanges by applying a force in a single direction.

In certain embodiments, it is said expansion ring (20) that is able to collaborate with a hollow tube (A1) used by said implantation instrument (A) for holding the implant (1), letting the expansion rod (A3) pass through the ring, while the central shaft (3) is able to collaborate with said expansion rod (A3) of said instrument (A) so that a pressing force exerted on said expansion rod (A3) sliding inside said hollow tube (A1) causes said central shaft (3) to move away from said ring (20), resulting in controlled expansion of the implant (1) dependent on the pressing force exerted on the expansion rod (A3).

In certain embodiments that are alternatives to the preceding ones, it is the proximal end of the central shaft (3) that is able to collaborate with said hollow tube (A1) used by said implantation instrument (A) for holding the implant (1), whereas said expansion ring or socket (20) is able to collaborate with said expansion rod (A3) of said instrument (A) so that a pressing force exerted on said expansion rod (A3) sliding inside said hollow tube (A1) causes said expansion ring or socket (20) to move away from said central shaft (3), resulting in controlled expansion of the implant (1) dependent on the pressing force exerted on the expansion rod (A3).

In certain embodiments, the central shaft (3) comprises a conduit (31) able to collaborate with said expansion rod (A3) which is, on the one hand, hollow and provided with at least one opening at its distal end and, on the other hand, able to be connected to a fluid-injection instrument (Ac) for conveying at least one fluid to the implant implantation site via the central shaft (3), and which is preferably provided with openings (32) to disgorge fluid along the length of the central shaft (3).

In certain embodiments, the flange-support arms (131, 141, 151) comprise two arms connected respectively near the proximal and distal ends of their respective flange (13, 14, 15) to provide support along the entire length of the flanges and limit the risk of them bowing or sagging.

In certain embodiments, at least one additional central support arm (130, 140, 150) is connected between a central portion of the central shaft and a central portion of the flanges (13, 14, 15), with hinges at the two ends of the support arm (130, 140, 150) to allow it to pivot.

In certain embodiments, two flanges (13, 14) are arranged one on each side of the central shaft (3) to provide a bearing surface to bear against the damaged bone tissue on each side of the implant, for example to restore a height or a width.

In certain embodiments, the implant comprises at least one additional flange (15), the distribution of the flanges about the central shaft (3) varying according to the number of them and/or according to what is needed in terms of surgical intervention, these preferably being equally angularly distributed radially with respect to the central shaft so as to apply uniform compression to the bone tissue at the periphery of the implant.

In certain embodiments, double support arms are provided to strengthen the structure. Furthermore, locking means are provided in certain instances, to prevent the implant from folding of its own accord. The very fine diameters of the implants and their central shafts are difficult to reconcile with screw threads for performing the expansion by a screwing action at the implant, although it is advantageous to perform a screwing action at the instrument actuating expansion, particularly when the expansion involves bringing the support arms closer to one another. Thus, as known from the prior art, it is possible for example to use a split ring housed in a circular recess of the implant and engaging with teeth on the push- or pull-shaft, which teeth are oriented in such a way as to allow this shaft to turn in only one direction, for example as depicted in FIG. 15C. Thus, the shaft may be actuated for expanding the flanges by rotating past successive teeth, thereby allowing the implant to be locked in the deployed configuration.

However, unlike certain implants of the prior art, where the structure serving as an expander (often with a traction axis) for bringing the two ends of the implant together and bringing the support arms closer must necessarily remain in place, the implants of the present application are deployed without any moving-together of the support arms, which advantageously allows these arms to be locked with a screw lock so that such teeth that make the task difficult and offer reduced reliability are not needed. Thus, for example and as depicted in FIGS. 15A and 15B, it is possible for example to use a threaded sleeve configured to be arranged in the hollow tube of the implantation instrument (A) holding the implant (and surrounding any fluid injection conduit that may be present inside it). Such a sleeve therefore has a screw thread intended to collaborate with a tapped thread belonging to the proximal end (11) of the implant and has actuating means for screwing or unscrewing (such as radial wings depicted in FIG. 15B). It is also possible to provide an instrument comprising a cannula (A1) that is free to rotate and translate inside the hollow tube (A0) and around the expansion rod (A3) of the instrument, and whose distal end has means for cooperating with the screw lock (VV) to drive it in rotation, for example by means of a shape complementary to that of the screw lock (VV) at its proximal end (the fins in the example in FIG. 15B). This cannula (A1) can then also serve as a fluid injection cannula for delivering cement into the implant.

In addition, the configuration of the implants of the present application offers a not-insignificant advantage as far as the reliability of expansion is concerned. Specifically, the fact that support arms are positioned at least at the ends of the flanges (and possibly with one or more reinforcing arms between the ends) enables the creation of deformable parallelograms that maintain their property of mutual-parallelism of their sides, unlike certain implants of the prior art where the support arms are mounted in opposition. This type of implant of the prior art generally requires for the arms to be provided in duplicate on each side in order to improve the reliability of expansion. The implants of the present application do not require the arms to be duplicated, although it does remain possible to do so, particularly in the case of implants of a large size and/or intended to bear a significant load. Thus, certain embodiments comprise support arms in duplicate, at least at one of the sites of these arms, and preferably at each of them, as for example depicted in FIG. 2B. In addition, such double arms may have a self-locking mechanism that locks them in the deployed configuration, such as, for example, teeth formed facing one another so that they engage with one another, for example as depicted for the central support arms (130, 140) in FIG. 2B.

The present application also relates to a system for orthopaedic treatment of damaged bone tissue, comprising a bone substitute cement and at least one instrument (A) for implantation and for injection (Ac) of cement into the implant (1), characterized in that it comprises an implant (1) according to various embodiments.

In certain embodiments, the instrument (A) for implantation and for injection (Ac) of cement comprises means for controlling the pressure and/or the aspiration of the cement so that the implant can be re-folded to the folded configuration if necessary. This type of means is widely known and may, for example, simply be based on a piston actuated in a cylinder, but may comprise more complex means, as is widely known in the field of the present application.

In certain embodiments, the implantation instrument (A) is distinct from but complements the injection instrument (Ac) the cement-injection canal of which passes through a canal inside the rod of the implantation instrument (A) that via its distal end holds the proximal end of the implant (1).

In certain embodiments, the implant may comprise a second sheet (10) surrounding the first sheet, made from the same material or another material, for example to provide thermal insulation to protect the tissue from the heat of polymerization. In that case, the ends comprise an additional ring for fixing this second sheet, maintaining a space between it and the first sheet, potentially with an inlet for injecting another fluid between the two. During manufacture, these two sheets can then be folded and rolled at the same time. These embodiments enable the injection site to be preformed (by compressing spongy bony tissue) enabling, for example, said fluid to be injected in two stages for better adjustment of the shape, of the resulting temperature in the tissue and/or of the rate of polymerization of the fluid.

Certain embodiments also relate to a method for manufacturing an implant according to various embodiments, characterized in that it comprises:
Obtaining an expandable implant with two flanges that can be parted under the effect of the ends of the implant being moved closer together by support arms that connect these ends to the flanges;
Closing the sheet on itself and welding it to form a generalized cylinder;
Inserting the closed sheet on a die in the shape of a generalized cylinder having a star-shaped base and referred to as a star-shaped rod (TE), the number of branches of the star defining the number of pairs of folds of said sheet of said implant;
Compressing the closed-up sheet between said die and a plurality of projecting elements of a shape that complements the hollows between the branches of the star;
Rolling the folds of said sheet around the longitudinal axis,
Inserting said expandable implant inside said compressed sheet;
Securing said sheet to the socket and the sleeve.

For example, rolling may be achieved by introducing the closed and pre-folded sheet into a conduit the diameter of which narrows progressively down to the desired diameter for the implant, by sliding and twisting the implant in this conduit (for example with a guide inside the sheet to prevent it from becoming crushed).

The act of securing to the sleeve and the socket will generally be achieved using welding (120), preferably with the sheet being crushed beforehand onto the circumference of the socket or the sleeve, for example by means of a compression ring (121), examples of which are depicted in certain figures. Specifically, while it is possible to weld directly, compressing the folds in place remains preferable.

The illustrative and nonlimiting figures of the present application will now be described in detail the better to explain the various embodiments and provide examples of structural elements that can be used in the foregoing context. That which follows must not be considered as being limiting since the various elements or components illustrated are merely examples and the figures may combine elements or components that are not necessarily dependent on one another.

FIG. 1A depicts a perspective view of an expandable implant according to a certain embodiment, without its casing, FIG. 1B depicts two perspective views of an implant, the top one with the implant fitted with its casing prior to the folding of the distal end of the casing and the bottom one after the folding of this distal end, and FIG. 1C depicts a perspective view of the implant of FIG. 1B but in the deployed configuration. In FIG. 1B, the deployable implant depicted has a deformable casing formed by a sheet (10) welded at the proximal end (11) to the sliding sleeve, while its distal end is closed on itself with lying-down and rolled folds compressed in contact with one another and secured together by a weld forming a distal closure (F). This distal closure (F) may preferably be folded back inside the deployable implant by a pushing force indicated by an arrow in the upper view of FIG. 1B, so as to obtain an implant in which the casing does not extend beyond the body of the implant, as is indicated in the lower view of FIG. 1B, thanks to the force applied. Finally, FIG. 1C shows a perspective view from the outside of this same implant once it has been deployed and the casing has been filled, with the closure (F) restraining the folds at the distal end.

It should also be noted that the articulations between the central shaft and the flanges in the examples depicted in particularly in the case of that of FIG. 1B differ according to the position of the arms with respect to the flange. Specifically, because of constraints associated with deployments achieved by the parting of the flanges, it is necessary in the case of flexible hinges as depicted in the figures for the indentation (removal of material) enabling articulation to be greater in size at the proximal end than at the distal end, because their respective axes of pivoting are different. It will also be noted that the hinges depicted in these figures of the present application are in fact flexible zones, thanks to these indentations or removals of material that confer flexibility on the material used, whether this be a material that is basically flexible (for example such as PEEK, polyether ether ketone) or one that is basically not (for example such as titanium alloys). Such flexible hinges require greater removals of material than in the case of mechanical hinges where such a requirement to remove is no longer needed, or even where there is rather a need to thicken the material in order to provide the hinge pin of the mechanical hinge. Thus, these flexible hinges are preferred in most cases.

FIG. 2A depicts a perspective view of an implant of the same type as FIG. 1C but with the casing sectioned in its middle part, FIG. 2B depicts a profile view of an expandable implant in the deployed configuration equipped with double support arms and having a self-locking mechanism, and FIG. 2C depicts a detail of the proximal end of an implant according to various embodiments. In particular, FIG. 2A depicts a perspective view with the casing shown partially in transparency (or sectioned) in order to show how the entity behaves following deployment. Unlike in the embodiments of FIGS. 1 and 2, FIGS. 7A and 7B depict perspective views of an implant according to other embodiments in which the expansion ring (or socket) (20) is a distal rather than a proximal ring to which a pushing force is applied in order to cause the flanges to part through the pivoting of the support arms. In this kind of embodiment, the casing will also be welded on the proximal end (11) to the ring via which the implant may be held by an implant-holder, while at the distal end the casing may be either welded to the ring (20) or left free with a distal closure (F) as in other embodiments. However, it is preferable to weld the distal end of the casing to the ring (20) because it is not possible to fold in the distal closure (F) as in the other embodiments since there is not the space between the support arm that there was in these other embodiments.

FIG. 2B depicts one example of certain embodiments in which each of the support arms or at least some of the support arms (130, 140, 131, 141) are duplicated into pairs of adjacent arms and could be triplicated in other embodiments. In addition, some of the support arms (the central arms (130, 140) in this example) have projections that complement those of the other arm of the same pair, so that in the deployed configuration the two projections come into abutment against one another so as to oppose the re-folding of the implant once a certain degree of expansion (separation) has been exceeded.

FIGS. 3A, 3B and 3C depict profile views of vertebrae that have respectively suffered anterior, median and posterior vertebral compression fractures (VCFs). The invention allows these kind of vertebral fracture to be treated by arranging the deployable implant in the correct position in the plane of the implantation site, using antero-posterior and/or medio-lateral positioning and adjusting the depth of insertion and/or the angle of insertion of the implant, according to the type of surgical approach being used (for example lateral, anterior, dorsal, transforaminal, transpedicular, etc.).

FIGS. 4A, 4B, 4C and 4D depict profile views of 4 expandable implants in the folded configuration according to different embodiments, with support arms of different lengths. Similarly, FIGS. 5A, 5B, 5C and 5D depict profile views of the implants of FIGS. 4A, 4B, 4C and 4D, respectively, but in the deployed configuration with their flanges nonparallel. In certain embodiments, the flanges are articulated to support arms (131, 141) the lengths of which differ from one flange to another in order to achieve asymmetric expansion. It will be appreciated that these FIGS. 4 and 5 represent nonlimiting examples of particularly advantageous embodiments in which the support arms have different lengths according to their position along the longitudinal axis. Thus, for example, in the case of FIGS. 4A and 5A, the flanges, once the implant has been deployed, are notably able to achieve kyphosis in the case of vertebral implantation, through the fact that the distance between the flanges at the distal end is shorter than the distance between the flanges at the proximal end, whereas FIGS. 4B and 5B depict examples in which the distance between the flanges at the distal end is greater than that at the proximal end. In addition, FIGS. 4C, 5C, 4D and 5D depict other particularly advantageous and unheard-of embodiments in which the flanges are able, during the course of their deployment, to adopt a shape different from that which they have in the folded position, thanks to their flexibility or to various notches distributed over at least one of their (internal or external) faces. For example, in FIGS. 4C and 5C, the flanges are concave in shape, which means to say that the distance(s) separating them at the distal and proximal ends is (are) greater than the distance separating them between these 2 ends. Conversely, in FIGS. 4D and 5D, the flanges once deployed are convex in shape, as a result of the fact that the distance(s) separating them at the proximal and distal ends is (are) less than the distance separating the flanges between these two ends. These various configurations are obtained through the fact that the support arms have length dimensions that differ from one arm to another along the longitudinal axis, and it is also possible for these lengths to differ between the arms of one flange compared to those of the arms of the other flange. In addition, in the embodiments in which the support arms have lengths that vary according to their position along the longitudinal axis, it is possible also to have different lengths from one flange to the other, for example in order to obtain a deployed implant in which one of the flanges is concave and the other convex. It will be appreciated that numerous combinations regarding the various flanges of the implant are thus possible (irrespective of the number of them). For example, by considering the upper half of one of FIGS. 4A to 4D or 5A to 5D, for one flange and the lower half of another of these figures, it will be appreciated that it is possible to have a large number of combinations each offering particular advantages depending on the geometry of the structure that is to be restored.

FIG. 6A depicts a view from above of a vertebra in which an implant according to various embodiments is implanted, FIG. 6B depicts a perspective view of a vertebra in which an implant of the prior art is implanted, and FIG. 6C depicts a perspective view of a vertebra in which an implant according to certain embodiments is implanted. It will be appreciated from these figures how the implant may be implanted in a vertebral body to treat a vertebral compression fracture and it may be seen that the implant is able to conform more reliably to the space that it fills thanks to flanges that are braced all the way to their ends, but also thanks to the casing which, once filled with cement, will completely fix the expanded implant and the bony structure.

FIG. 7A depicts certain embodiments in which the extension of the implant is the reverse of that of the other embodiments, namely in which the expansion ring (20), instead of being positioned at the proximal end in order to pull on the flanges, is positioned at the distal end in order likewise to pull on the flanges but towards the distal end thanks to a pressing force transmitted through the implant and particularly along the central shaft. In these embodiments, the proximal end (11) therefore has passing through it a conduit through which an instrument is capable of passing as far as the expansion ring (20) at the distal end in order to apply a pushing force while the proximal end (11) is held fixed by an implant holder. The flanges therefore part as a result of the pivoting of the support arms (131, 141) with respect to the central shaft, in a movement oriented towards the distal end. These embodiments may be particularly advantageous particularly in instances in which it is preferable to limit the stresses on the bone tissue at the proximal end and limit the size of the implant at the proximal end. Specifically, what is thus obtained is an implant that deploys towards the distal end, there remaining at the proximal end only part of the central shaft (3) and the proximal end by which the implant was held by the implant holder. The flanges thus deploy towards the front, thereby limiting the risks of breakage at the proximal end for example as depicted in FIG. 7B in the case of a vertebra where it may be advantageous not to apply pressure towards the proximal part which could, for example, be situated near a wall of bone tissue. In the example of FIG. 7B, the implant is deployed by applying a pushing force causing the flanges to pivot towards the distal end, and the posterior wall of the vertebral body is thus preserved and the risks of breakage are limited. FIG. 7C on the other hand in fact depicts a variant that is similar to certain implants of the prior art having just one flange, but with the arm mechanism pivoting in the same direction which is a concept common to most of the embodiments detailed in the present application. This kind of mechanism with just one flange therefore allows deployment in just one given direction perpendicular to the longitudinal axis, which may be beneficial in certain cases. The present disclosure naturally allows for this kind of embodiment as all that is required is for the casing to be welded to the proximal end (11).

FIGS. 8A, 8B and 8C depict, respectively, a view from above, a face-on view of the profile view of an expandable implant with three flanges according to certain embodiments. In particular, FIGS. 8A, 8B and 8C depict embodiments in which the implant comprises more than two flanges and particularly in these examples a third flange, but it is clear that the invention may also cover the case of four, or even more, flanges, although in general three or four flanges will suffice because three-dimensional deployment will generally be satisfactory with such configurations. In these embodiments, it is clear that deployment of the implant makes it possible to restore an additional number of bony structures compared with implants comprising just two flanges, particularly long bones. The deployment of such types of implant provides a better guarantee of the expansion volume obtained compared with that desired, whether or not the implant is supplemented by the injection of cement (and particularly whether or not it has a casing providing containment of the volume of injected cement). In addition, as mentioned hereinabove, the use of support arms of different sizes makes it possible to obtain flanges with various shapes once deployed, and for example a concave upper flange and two planar lateral flanges that are either straight or inclined, or any combination between these straight-planar, inclined-planar or concave or convex configurations.

FIG. 9A depicts a perspective view of an expandable implant in a semi-deployed configuration, according to certain embodiments, FIG. 9B depicts a perspective view of a sheet used for the manufacture of an expandable implant according to certain embodiments in the semi-folded configuration, and FIG. 9C depicts a perspective view of this same sheet in the folded configuration.

FIG. 10A depicts a perspective view of an expandable implant in the folded configuration with a line (110) of welding at the proximal end (11) and a line (120) of welding at the distal end (12), and FIG. 10B depicts an enlargement of FIG. 10A at the distal end, showing the distal cup that closes off the distal end of the implant.

FIG. 11A depicts a perspective view of a guide tool that guides the folding of a sheet of an expandable implant according to certain embodiments, the sheet being guided by means of a guide tube, and FIG. 11B depicts a profile view of this same tool with the sheet folded, the enlargements 11C and 11D depicting profile views of the overlapping of the sheet at its closure according to two different examples of embodiment. In order to obtain a sheet (10) that is folded on itself in the shape of a cylinder, use is preferably made of an internal guide (TG) as for example a guide tube (but potentially a roller of which the relative position with respect to the sheet is preferably able to move parallel to the longitudinal axis). This guide allows the sheet (10) to be rolled up on itself and introduced into an external guide (GR), as for example a folding guide comprising a conduit to accept the folded sheet as illustrated for example in FIG. 11A, or an external roller preferably able to move in a manner complementary to the internal guide, so as to enable welding as the rollers gradually progress along the longitudinal axis that corresponds to the height of the cylinder. Guiding the sheet using at least one of the internal and external guides enables the two edges (or ends) of the sheet (10) initially of rectangular shape and bent round on itself to be positioned in such a way that two of its edges are partially superposed. These edges positioned one above the other may then be welded together, for example as depicted in FIG. 11C, but it is possible to create 2 folds in opposing directions on each of these two edges of the sheet in order to obtain interlocked folds, for example as depicted in FIG. 11D, this making the welding easier particularly by limiting the risks of holing the sheet and/or making it possible to improve the reliability and stability of the implant particularly at the time of its subsequent deployment.

FIG. 12 depicts a perspective view of a tool for the pre-folding of sheets for the expandable implant according to certain embodiments, using a pre-folding plate. This FIG. 12 illustrates a preferred embodiment of a tool enabling the creation of an alternation of long folds and short folds or an alternation of symmetrical folds depending on the shape of the ends of the pre-folding cams (CP) that collaborate with a complementing star-shaped rod for pre-folding the sheet between the rod and the cams. Specifically, certain embodiments of such a tool have rails (RC) bearing pre-folding cams (CP) which may have a first cam angle (CP1) and a second cam angle (CP2) that are different so as to obtain long folds and short folds, or two cam angles that are identical in order to obtain symmetrical folds. The folding cams, by sliding along their respective cam rail, enable the sheet (10), previously closed on itself in cylindrical form, to be deformed (e.g. crushed) and pre-folded. To do that, this sheet (10) is inserted over a star-shaped rod (TE) the cross section of which has the shape of a star with asymmetrical branches in the case of long folds and short folds, or with symmetrical branches in the case of symmetrical cams and folds, as illustrated in FIGS. 13B and 13D respectively.

FIG. 13A depicts an enlargement of FIG. 12, FIGS. 13B, 13C and 13D depict the views from above of various embodiments of the pre-folding tool with a star-shaped rod and a sheet of the implant slipped around it. In the enlargement of part of FIG. 12 that is FIG. 13A, it is easier to see how the pre-folding cams and the star-shaped rod collaborate. FIG. 13C depicts a variant embodiment in which the star-shaped rod has branches the dimensions of which vary around the circumference of the star-shaped rod, which means that the corresponding cams will have shapes that differ from one cam to another, whether for obtaining long folds and short folds as in the example depicted, or symmetrical folds, so that the folded sheet in the form of an asymmetric flattened cylinder will, once pre-folded by this tool, have an asymmetrical shape that it will maintain also once deployed.

FIG. 14A shows an example of a folded sheet in the form of a cylinder that has been pre-folded with symmetrical folds, and FIG. 14B shows this same sheet condensed in on itself to reduce its diameter, for example to reduce it as far as possible until its internal folds (102) are adjacent to one another. It will be noted that in such an embodiment it is also possible to reduce the diameter of the casing formed by the sheet, for example by introducing it into a tapering tube or some other means for compressing the periphery of the sheet and notably the external folds (101).

FIG. 15A depicts a perspective view of an expandable implant in the deployed position and equipped with a lock that holds the implant in its deployed configuration, FIG. 15B depicts a detail of the proximal end of an implant of the type of FIG. 15A, with the lock on the outside of the implant according to certain embodiments, and FIG. 15C depicts a detail of the proximal end of an implant according to certain embodiments with another type of lock on the outside of the implant. In particular, FIGS. 15A and 15B depict embodiments in which the implants, once deployed, can be locked by a screw lock (VV). In such embodiments, the proximal end (11) has a tapped threaded conduit into which there may be introduced a screw lock (VV) that has a screw thread on its periphery to collaborate with this thread. Tightening the screw lock (VV) applies pressure to the central shaft (3) to prevent it from moving towards the proximal end and causing the re-folding of the implant which thus finds itself locked in the deployed position. Such a lock is preferably provided with a central bore and possibly with distal holes to allow cement to be injected into the implant, as in certain embodiments already described hereinabove. Moreover, in order to tighten this screw lock (VV), its proximal end is fitted with means to collaborate with a screw-turning tool, such as for example peripheral wings depicted in FIGS. 15A and 15B. By contrast, in FIG. 15C, the locking mechanism relies on teeth. This mechanism comprises a toothed lock (VC) which contains a circumferential groove able to accept a split ring acting as a locking clip intended to collaborate with a circumferential housing inside the conduit into which the toothed lock is inserted to form this clip. As depicted in FIG. 15C, as the toothed lock is pushed in, the split ring engages with teeth in the conduit of the implant which can thus be locked incrementally by this lock pressing against interior teeth in the conduit of the implant. These teeth are preferably asymmetrical so as to allow the lock to be withdrawn only towards the outlet, thereby keeping the implant secure in the deployed position and preventing it from re-folding under the force exerted by the surrounding tissue.

In certain embodiments, the implant may comprise a second sheet (10b) surrounding the first sheet, made from the same material or another material, to form a double casing, for example as depicted in FIG. 10C. Such a double casing may offer numerous assorted advantages, particularly of providing thermal insulation to protect the tissue from the heat of polymerization (thanks for example to a fluid that limits the transmission of heat) or simply of providing additional safety to ensure that cement does not leak out if one of the sheets becomes torn. In that case, at least one of the ends of the implant, particularly the proximal end (11), may comprise an additional ring or cup concentric with the first ring or with the first cup or, for example as depicted in FIG. 10C, a double ring, for fixing this second sheet (10b), keeping a space between it and the first sheet (10), but it is possible to secure these together at the ends. In the case of two more widely spaced sheets, it is possible to provide an injection inlet, for injecting, between the two sheets (10, 10b), a fluid different from or identical to the first, for example by means of spacers between the first proximal ring (11) and the second ring (11b) which are concentric and thus form a conduit of annular cross section between them, for the injection of this second fluid (such as for example a lubricating fluid that improves the sliding of one sheet relative to the other and thus facilitates deployment). During manufacture, these two sheets can then be folded and rolled at the same time or successively. These embodiments enable the injection site to be preformed (by compressing spongy bony tissue) enabling, for example, said fluid to be injected in two stages for better adjustment of the shape, of the resulting temperature in the tissue and/or of the rate of polymerization of the fluid (for example by adjusting the mix of the compounds of the cement). Such a double-sheet implant (1) therefore requires a double cannula comprising two concentric conduits each opening into one of the spaces formed by each of the sheets, via the double proximal ring (11, 11b), as the person skilled in the art will appreciate from FIG. 10C without further explanation being required.

The present application describes various technical and advantageous features with reference to the figures and/or to various embodiments. The person skilled in the art will appreciate that the technical features of one given embodiment may in fact be combined with features of another embodiment unless the contrary is explicitly mentioned or unless it is obvious that these features are incompatible or that combining them will not provide a solution to at least one of the technical problems mentioned in the present application. In addition, the technical features described in one given embodiment may be taken in isolation from the other features of this embodiment unless the contrary is explicitly mentioned.

### Detailed List of References in the Figures

1 implant
10 sheet
10b second sheet
11 proximal end
11b double ring
101 antiform fold
102 synform fold
110 proximal weld
12 distal end
120 distal weld (fluidtight connection)
121 compression fixing (e.g. split ring)
3 central shaft
31 central-shaft conduit
32 openings in the central-shaft conduit
13 first flange
14 second flange
15 third flange
20 expansion ring
131 first-flange support arm
141 second-flange support arm
151 third-flange support arm
132 first-flange expansion arm
142 second-flange expansion arm
152 third-flange expansion arm
130 first-flange central support arm
140 second-flange central support arm
150 third-flange central support arm
A implantation instrument
Ac fluid-injection instrument
A1 hollow holding tube
A12 distal end-cap
A3 expansion rod
TG internal guide
GR external guide
PP pre-folding plate
ET star-shaped rod
CP pre-folding cam
CP1 pre-folding cam first angle
CP2 pre-folding cam second angle
RC cam rail
VV screw lock
VC toothed lock

1. An expandable bone implant (1) for veterinary orthopaedic surgery for restoring the volume and/or geometry of a bone by expansion between a folded configuration and a deployed configuration, said implant comprising a central shaft (3) and extending along a longitudinal axis (L) between a proximal end (11) connectable with an implantation instrument (A) for holding the implant and a distal end (12) intended to be first inserted into the bone, at least two faces, for example, an upper and a lower face, of the implant each comprising at least one flange (13, 14, 15) for contact with bone tissue, each of the flanges being supported by at least two support arms (131, 141, 151) each, by means of a hinge on the central shaft (3) and a hinge under the respective flange (13, 14, 15) of each of said support arms (131, 141, 151);
wherein:
an expansion ring or socket (20) is arranged on the same axis as said central shaft (3);
at least two expansion arms (132, 142, 152) each have a hinge connecting them to one of the ends of one of the flanges (13, 14, 15) and a hinge connecting them to said expansion ring or socket (20);
said expansion ring or socket (20) and the proximal end of the central shaft (3) can be actuated in order to cause separation between said socket (20) and said central shaft (3), applying traction to the flanges (13, 14, 15), via the expansion arms (132, 142, 152), thereby causing said support arms (131, 141, 151) to pivot, thus causing the flanges (13, 14, 15) to move away from the central shaft (3) to result in controlled expansion of the implant (1) between said folded configuration and said deployed configuration;
and the implant comprises a casing enclosing said implant from the proximal end (11) to the distal end (12) and in that:
said casing is formed by a sheet (10) made of a biocompatible metal alloy, closed on itself in a sealed manner;
said sheet (10) has, at least in the folded configuration, a plurality of pairs of folds, each of the pairs comprising an antiform fold (101), referred to as convex, and a synform fold (102), referred to as concave, said folds lying on top of each other in a folded configuration so that the surfaces present between each of said convex and concave folds are rolled around the longitudinal axis (L);
said proximal end (11) is extended by a sealing sleeve secured in a sealed manner to the lying-down and rolled folds of said sheet (10) over the entire periphery of the proximal end (11);
said distal end (12) is extended by a socket secured, in a sealed manner, to the lying-down and rolled folds of said sheet (10) over the entire periphery of the distal end (12) of said implant (1);
said sheet (10) is plastically deformable to allow expansion of the implant from the folded configuration to the deployed configuration, forming a sealed casing enclosing the implant and making it possible to avoid leakage when a fluid is injected into the implant (1) and the casing.

2. The expandable bone implant according to claim 1, wherein said expansion ring (20) is able to collaborate, with a hollow tube (A1) used by said implantation instrument (A) for holding the implant (1), letting the expansion rod (A3) pass through the ring, while the central shaft (3) is able to collaborate with said expansion rod (A3) of said instrument (A) so that a pressing force exerted on said expansion rod (A3) sliding inside said hollow tube (A1) causes said central shaft (3) to move away from said ring (20), resulting in controlled expansion of the implant (1) dependent on the pressing force exerted on the expansion rod (A3).

3. The expandable bone implant according to claim 1, wherein the proximal end of the central shaft (3) is able to collaborate with said hollow tube (A1) used by said implantation instrument (A) for holding the implant (1), whereas said expansion ring or socket (20) is able to collaborate with said expansion rod (A3) of said instrument (A) so that a pressing force exerted on said expansion rod (A3) sliding inside said hollow tube (A1) causes said expansion ring or socket (20) to move away from said central shaft (3), resulting in controlled expansion of the implant (1) dependent on the pressing force exerted on the expansion rod (A3).

4. The expandable bone implant according to claim 1, wherein the central shaft (3) comprises a conduit (31) able to collaborate with said expansion rod (A3) which is, on the one hand, hollow and provided with at least one opening at its distal end and, on the other hand, able to be connected to a fluid-injection instrument (Ac) for conveying at least one fluid to the implant implantation site via the central shaft (3), and which is preferably provided with openings (32) to disgorge fluid along the length of the central shaft (3).

5. The expandable bone implant according to claim 1, wherein the flange-support arms (131, 141, 151) comprise two arms connected respectively near the proximal and distal ends of their respective flange (13, 14, 15) to provide support along the entire length of the flanges and limit the risk of them bowing or sagging.

6. The expandable bone implant according to claim 1, wherein at least one additional central support arm (130, 140, 150) is connected between a central portion of the central shaft and a central portion of the flanges (13, 14, 15), with hinges at the two ends of the support arm (130, 140, 150) to allow it to pivot.

7. The expandable bone implant according to claim 1, wherein the implant comprises two flanges (13, 14) arranged one on each side of the central shaft (3) to provide a bearing surface to bear against the damaged bone tissue on each side of the implant, for example to restore a height or a width.

8. The expandable bone implant according to claim 1, wherein the implant comprises at least one additional flange (15), the distribution of the flanges about the central shaft (3) varying according to the number of them and/or according to what is needed in terms of surgical intervention, these preferably being equally angularly distributed radially with respect to the central shaft so as to apply uniform compression to the bone tissue at the periphery of the implant.

9. The expandable bone implant according to claim 1, wherein the distance between a synform fold and the next antiform fold is longer than the distance between an antiform fold and the next synform fold to make it easier to roll the folds around the longitudinal axis (L) of the implant in the folded configuration.

10. The expandable bone implant according to claim 1, wherein said sealing sleeve extends said proximal end (11), parallel to the longitudinal axis (L), to a distance that is greater than or equal to that to which the flanges extend from the centre of the implant (1).

11. The expandable bone implant according to claim 1, wherein said sealing sleeve has a through-opening of which the diameter is greater than or equal to that of the opening of the sliding sleeve, so that these two sleeves, the sealing sleeve and the sliding sleeve, form an entrance to the inside of the hollow body of the implant (1) from a conduit of an implantation instrument (A) holding the implant at the proximal end, able to convey a fluid that is to be injected into said implant.

12. The expandable bone implant according to claim 1, wherein, in the deployed position, it comprises a middle portion between its two ends that has the shape of a generalized cylinder of a length greater than or equal to that of the flanges, with possible and partial persistence of said folds, said middle portion being extended, at the end corresponding to the proximal end (11), by a frustoconical portion connecting the middle portion to the sleeve and, at the end corresponding to the distal end (12), by a frustoconical portion connecting the middle portion to the socket, the frustoconical portions having a permanent persistence of at least part of the lying-down and rolled folds near the proximal end (11) and distal end (12).

13. The expandable bone implant according to claim 1, wherein said sheet is plastically deformable also from the folded configuration to the deployed position, in particular as a result of the persistence of the lying-down and rolled folds at the proximal and distal ends, enhancing the reversibility of the expansion.

14. The expandable bone implant according to claim 1, wherein said central shaft (3) is able to collaborate with and/or is extended beyond the distal end of an implantation instrument (A) at the proximal end of the implant and having an interior conduit in communication with a conduit (31) formed in said central shaft and opening onto the space formed by the parting of the flanges, via at least one opening (32) allowing said fluid to be injected into the implant (1).

15. The expandable bone implant according to claim 1, wherein said sheet (10) is secured at the proximal end (11) by welding (110) that fixes the proximal end of the lying-down and rolled folds against the exterior wall of said sliding sleeve, whereas the distal end of the sheet (10) is either closed on itself with its lying-down and rolled folds compressed in contact with one another and secured to one another by a weld that forms a distal closure (F), or secured at the distal end (12) by welding (120) that fixes the distal end of the lying-down and rolled folds against the exterior wall of said pull-socket (20)

16. The expandable bone implant according to claim 1, wherein said sheet is compressed around the sleeve of the proximal end (11) and/or around the socket of the distal end (12) by a compression ring (121) that holds the lying-down and rolled folds against the exterior wall of said sleeve and/or of said socket.

17. The expandable bone implant according to claim 1, wherein the folds are, at least in the folded configuration, parallel to the longitudinal axis (L).

18. The expandable bone implant according to claim 1, wherein the sheet also comprises at least one pair of folds (a synform fold and an antiform fold) of axis not parallel to the longitudinal axis (L), preferably perpendicular so that the implant can expand also lengthwise, or oblique so that the implant can expand in a curved manner.

19. The expandable bone implant according to claim 1, wherein the number of pairs of folds is comprised between 3 and 16, generally 4 to 12, and preferably of the order of 8.

20. The expandable bone implant according to claim 1, wherein the sheet (10) has a thickness comprised between 3 and 100 microns, generally between 6 and 50, and preferably 10 and 30 microns.

21. The expandable bone implant according to claim 1, wherein the sheet (10) is made of titanium alloy.

22. The expandable bone implant according to claim 1, wherein the distance between the folds is variable for one lateral face of the implant to the other, so that the shape of the implant in the deployed configuration is curved and/or asymmetric transversely to the longitudinal axis (L).

23. System for orthopaedic treatment of damaged bone tissue, comprising a bone substitute cement and at least one instrument (A) for implantation and for injection (Ac) of cement into the implant (1), characterized in that it comprises an implant (1) according to claim 1.

24. System according to claim 23, wherein the instrument for implantation and for injection of cement comprises means for controlling the pressure and/or the aspiration of the cement so that the implant can be re-folded to the folded configuration if necessary.

25. System according to claim 23, wherein the implantation instrument is distinct from but complements the injection instrument the cement-injection canal of which passes through a canal inside the rod of the implantation instrument that via its distal end holds the proximal end of the implant.

26. Method for manufacturing an implant according to claim 1, wherein the method comprises:
Obtaining an expandable implant with two flanges that can be parted under the effect of the ends of the implant being moved closer together by support arms that connect these ends to the flanges;
Closing the sheet on itself and welding it to form a generalized cylinder;
Inserting the closed sheet on a die in the shape of a generalized cylinder having a star-shaped base and referred to as a star-shaped rod (TE), the number of branches of the star defining the number of pairs of folds of said sheet of said implant;
Compressing the closed-up sheet between said die and a plurality of projecting elements of a shape that complements the hollows between the branches of the star;
Rolling the folds of said sheet around the longitudinal axis,
Inserting said expandable implant inside said compressed sheet;
Securing said sheet to the socket and the sleeve.
